(19) United States
(12) Patent Application Publication
(10) Pub. No.: US 2019/0387728 A1
(43) Pub. Date: Dec. 26, 2019

(54) FISHING TACKLE BUCKET ATTACHMENT

(71) Applicant: ACME UNITED CORPORATION, Fairfield, CT (US)

(72) Inventors: Richard S. Constantine, Monroe, CT (US); Yang Tan, Guangzhou (CN)

(73) Assignee: ACME UNITED CORPORATION, Fairfield, CT (US)

(21) Appl. No.: 16/018,395

(22) Filed: Jun. 26, 2018

(51) Int. Cl. A01K 97/06

(52) U.S. Cl. CPC A01K 97/06; A01K 97/05

(57) ABSTRACT

A fishing tackle module is provided for removable attachment to the rim of a bucket. The module includes a curved body member having a flanged leading edge adapted for engagement with the rim of a bucket, a trailing edge, and a surface that extends between the flanged leading edge and the trailing edge; a plurality of enlarged openings formed through the surface at spaced intervals; a plurality of apertures formed through the surface at spaced intervals adjacent the trailing edge; and a sheath engaged with and extending downwardly from one of the enlarged openings.

### FIELD OF THE INVENTION

The present disclosure is directed generally to a fishing tackle module for attachment to a bucket.

### BACKGROUND

Fisherman will typically use a bucket for holding bait fish, caught fish, and various other items. Tackle, such as lures, pliers, knives, dehookers, and the like are also typically carried in a tool box or other storage bin. While having multiple accessories to carry to and from a boat or fishing spot is feasible, it can also require multiple trips when also carrying poles, reels and other fishing gear. In addition, having multiple accessory bins in a limited space on a boat, for example, can become a nuisance and provide a lack of organization that result in lost/misplaced tackle.

Accordingly, there is a need in the art for a storage center that provides organization to fishing tackle.

### SUMMARY

The present disclosure is directed to a fishing tackle module that attaches to the rim of a bucket.

According to an aspect a fishing tackle module is provided for removable attachment to the rim of a bucket, comprising: a curved body member having a flanged leading edge adapted for engagement with the rim of a bucket, a trailing edge, and a surface that extends between the flanged leading edge and the trailing edge; a plurality of enlarged openings formed through the surface at spaced intervals; a plurality of apertures formed through the surface at spaced intervals adjacent the trailing edge; and a sheath engaged with and extending downwardly from one of the enlarged openings.

According to an embodiment, the plurality of enlarged openings is of at least two different shapes.

According to an embodiment, at least some of the plurality of enlarged openings is rectangular in shape.

According to an embodiment, at least some of the plurality of enlarged openings are circular in shape.

According to an embodiment, the surface is planar.

According to an embodiment, the module further comprises a wall extending downwardly from the surface at a position between the flanged leading edge and the trailing edge.

According to an embodiment, the interior surface of the flanged leading edge is coated with a non-slip material.

According to an aspect a method is provided for assembling fishing tackle on a fishing tackle module that attaches to the rim of a bucket and that includes a curved body member having a flanged leading edge adapted for engagement with the rim of a bucket, a trailing edge, and a surface that extends between the flanged leading edge and the trailing edge, a plurality of enlarged openings formed through the surface at spaced intervals, a plurality of apertures formed through the surface at spaced intervals adjacent the trailing edge, and a sheath engaged with and extending downwardly from one of the enlarged openings, comprising the steps of: placing a knife in the sheath; placing fishing pliers in one of the plurality of enlarged openings; and placing a fishing hook in one of the plurality of apertures.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a first perspective view of a fishing tackle module shown attached to a bucket and loaded with fishing tackle, in accordance with an embodiment.

FIG. 2 is a second perspective view of a fishing tackle module shown attached to a bucket, in accordance with an embodiment.

FIG. 3 is a third perspective view of a fishing tackle module shown in spaced relation to a bucket, in accordance with an embodiment.

FIG. 4 is a perspective view of just the fishing tackle module, in accordance with an embodiment.

FIG. 5 is a top plan view of just the fishing tackle module, in accordance with an embodiment.

FIG. 6 is a bottom plan view of just the fishing tackle module, in accordance with an embodiment.

FIG. 7 is a left side elevation view of just the fishing tackle module, in accordance with an embodiment.

FIG. 8 is a right side elevation view of just the fishing tackle module, in accordance with an embodiment.

FIG. 9 is a front elevation view of just the fishing tackle module, in accordance with an embodiment.

FIG. 10 is a rear elevation view of just the fishing tackle module, in accordance with an embodiment.

### DETAILED DESCRIPTION OF EMBODIMENTS

The present disclosure describes a fishing tackle module for attachment to a bucket. The fishing tackle module is adapted to hold several different types of tools and accessories used in fishing.

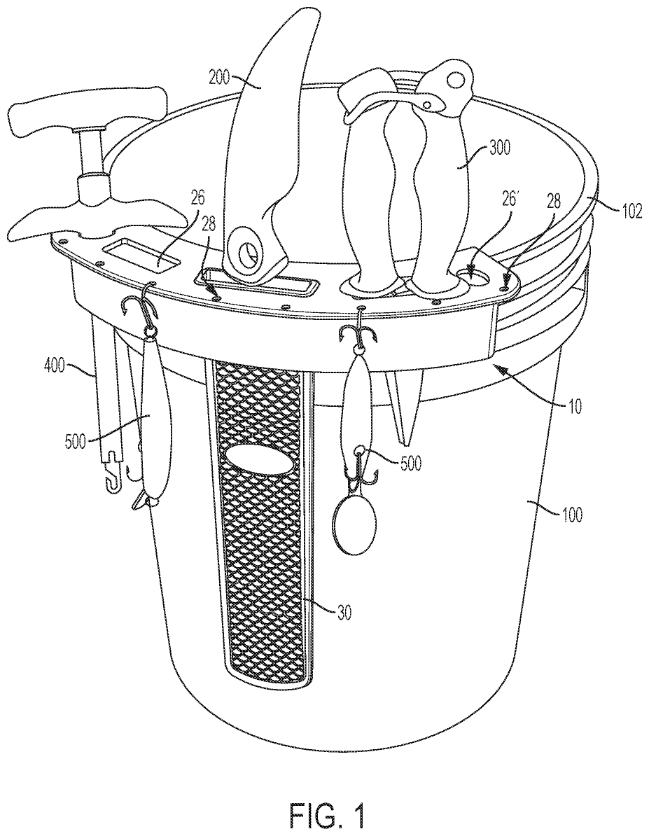

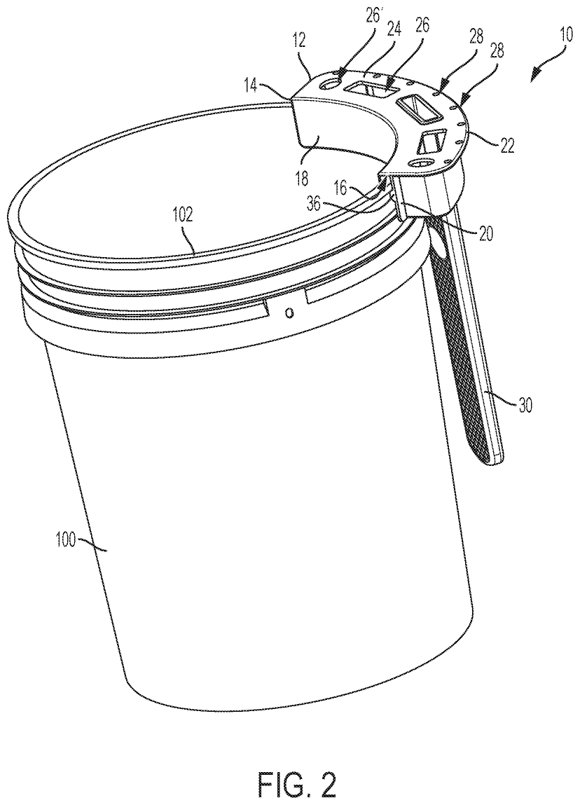

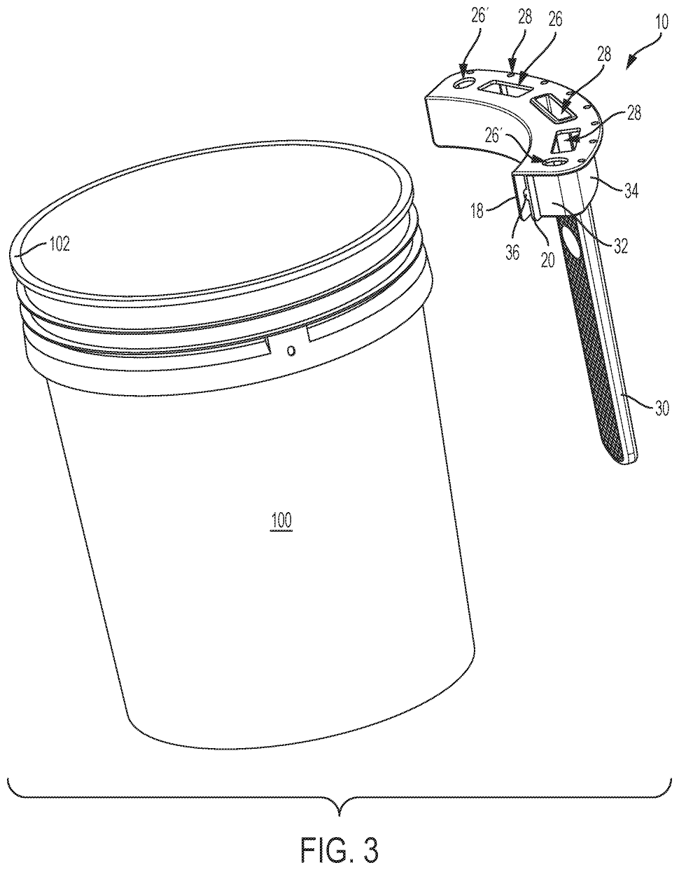

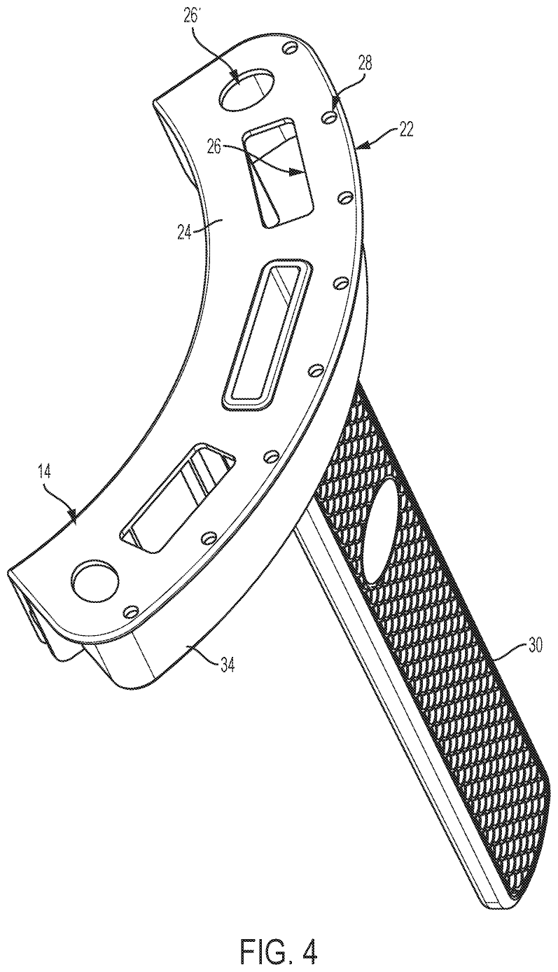

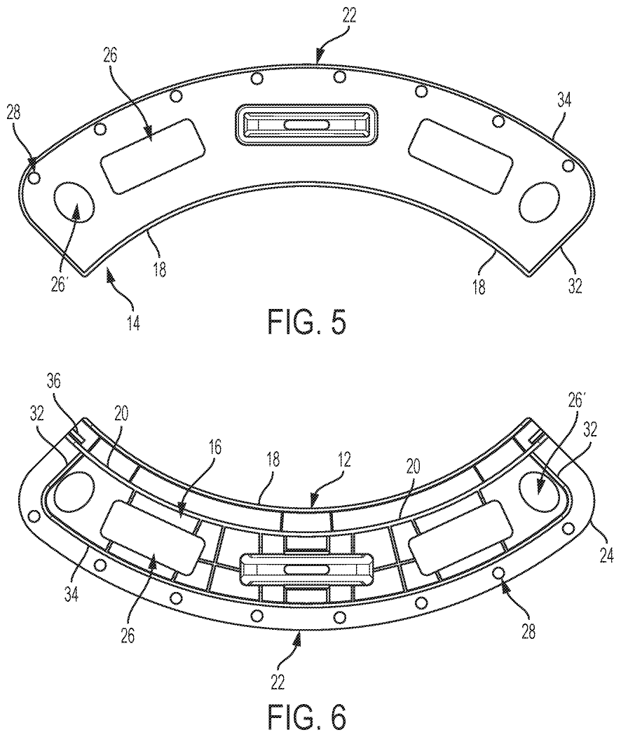

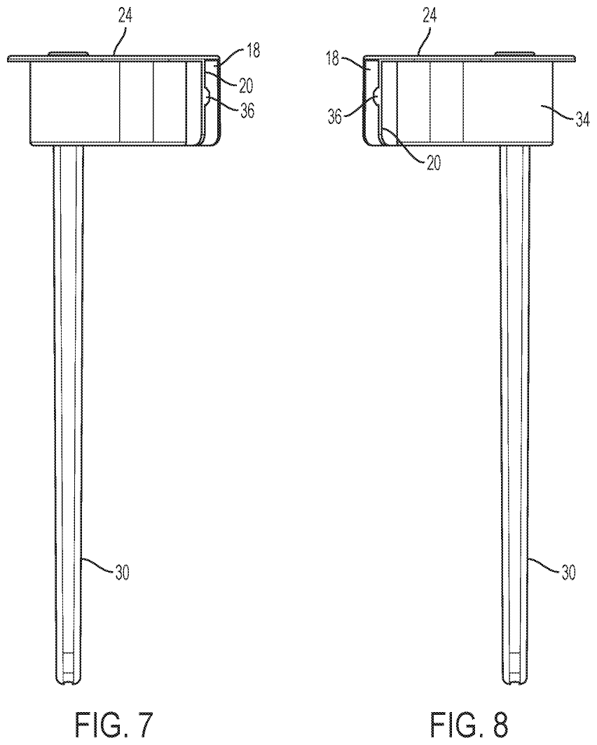

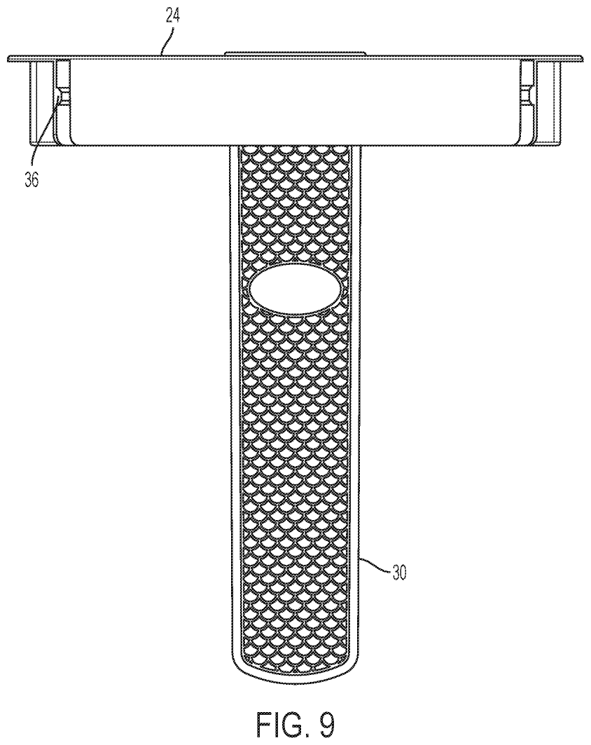

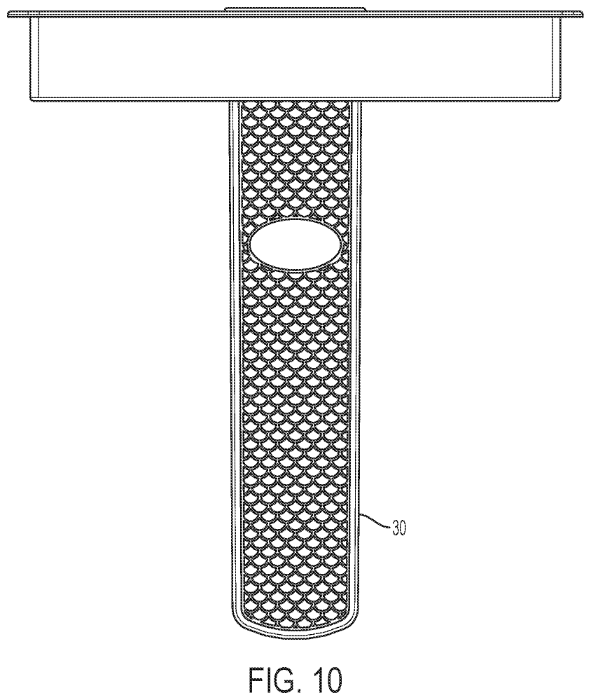

Referring to FIG. 1, in one embodiment, is a fishing tackle module, designated generally by reference numeral 10, which is adapted to attach to the rim 102 of a conventional bucket 100. Fishing tackle module 10 is adapted to hold a variety of fishing tackle such as, for example, a knife 200, pliers 300, a dehooker 400, as well as lures 500, among other typical fishing tackle/accessories, as further explained herein.

Fishing tackle module 10 comprises a curved body 12 having a flanged leading edge 14 defined by channel 16 formed between a pair of downwardly extending walls 18 (adapted to position within bucket 100), 20 (adapted to position outside bucket 100); a trailing edge 22; an upper surface 24, preferably planar, that extends between leading edge 14 and trailing edge 22 and through which are formed a plurality of enlarged openings 26 and smaller apertures 28. A sheath 30 extends downwardly from and can be integrally molded into or separately mounted within one of the enlarged openings 26 for purposes of safely stowing knife 200. The interior surface of the walls defining channel 16 are coated with a non-slip material, such as silicone, to prevent inadvertent slippage of the module 10 when mounted on bucket 100, and also provide a more secure attachment to bucket 100 (for when a differently sized bucket might be used and may not conform perfectly to the dimensions of channel 16).

Enlarged openings 26 are provided in two different shapes: rectangular 26 and circular 26′, and are positioned in spaced intervals around upper surface 24, and are sized to permit conventional tackle, such as knives 200 and pliers 300 pass though opening 26 and dehooker 400 to pass through opening 26′ while still securely retaining them therewithin. Apertures 28 are spaced in intervals around the outer periphery of upper surface 24, adjacent trailing edge 22, and are sized to securely receive a hook from a lure 500 therein, thereby permitting lures to overhang the edge of module 500.

To structurally reinforce flanged leading edge 14, a pair of sidewall ribs 32 extends rearward from the edges of wall 20 and forward from a rear wall 34 that extends downwardly from and around body 14 in spaced relation to wall 20. Wall 34 is positioned a slight distance forward of the trailing edge 22 and open space is enclosed between the walls 20, 32, and 34 to permit tackle 300, 400, and 500 to pass therethrough as best seen in FIG. 6.

To secure the attachment of module 10 to rim 102, a shelf/ledge 36 is formed on the interior facing surface of wall 20 a light distance beneath surface 24 (and the standard distance associated with rim 102 on a conventional bucket 100). Ledge/shelf 36 engages the bottom of rim 102 to assist in securing the attachment of module 10 to bucket 100.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A fishing tackle module for removable attachment to the rim of a bucket, comprising:
a. a curved body member having a flanged leading edge adapted for engagement with the rim of a bucket, a trailing edge, and a surface that extends between the flanged leading edge and the trailing edge;
b. a plurality of enlarged openings formed through the surface at spaced intervals;
c. a plurality of apertures formed through the surface at spaced intervals adjacent the trailing edge; and
d. a sheath engaged with and extending downwardly from one of the enlarged openings.

2. The fishing tackle module according to claim 1, wherein the plurality of enlarged openings is of at least two different shapes.

3. The fishing tackle module according to claim 1, wherein at least some of the plurality of enlarged openings are rectangular in shape.

4. The fishing tackle module according to claim 1, wherein at least some of the plurality of enlarged openings are circular in shape.

5. The fishing tackle module according to claim 1, wherein the surface is planar.

6. The fishing tackle module according to claim 1, further comprising a wall extending downwardly from the surface at a position between the flanged leading edge and the trailing edge.

7. The fishing tackle module according to claim 1, wherein the interior surface of the flanged leading edge is coated with a non-slip material.

8. A method for assembling fishing tackle on a fishing tackle module that attaches to the rim of a bucket and includes a curved body member having a flanged leading edge adapted for engagement with the rim of a bucket, a trailing edge, and a surface that extends between the flanged leading edge and the trailing edge, a plurality of enlarged openings formed through the surface at spaced intervals, a plurality of apertures formed through the surface at spaced intervals adjacent the trailing edge, and a sheath engaged with and extending downwardly from one of the enlarged openings, comprising the steps of:
a. placing a knife in the sheath;
b. placing fishing pliers in one of the plurality of enlarged openings; and
c. placing a fishing hook in one of the plurality of apertures.
